(19) United States
(12) Patent Application Publication
(10) Pub. No.: US 2014/0303907 A1
(43) Pub. Date: Oct. 9, 2014

(54) SYSTEMS AND METHODS FOR DYNAMIC FORCE MEASUREMENT

(71) Applicants: Kevin M. Roughen, Manhattan Beach, CA (US); Myles L. Baker, Long Beach, CA (US); Dan Stuewe, Costa Mesa, CA (US)

(72) Inventors: Kevin M. Roughen, Manhattan Beach, CA (US); Myles L. Baker, Long Beach, CA (US); Dan Stuewe, Costa Mesa, CA (US)

(21) Appl. No.: 13/857,947

(22) Filed: Apr. 5, 2013

(51) Int. Cl. G01M 9/08; G01L 7/00

(52) U.S. Cl. CPC G01M 9/08; G01L 7/00
USPC 702/41

(57) ABSTRACT

Systems and methods for dynamic force measurement are disclosed. A method in accordance with one embodiment includes applying forces to a model in at least one direction at at least one location, receiving information from at least one sensor, and identifying a math model of a model support structure. In particular embodiments, the method can further include generating a force estimator. In further particular embodiments, the method the force estimator can be an optimal unbiased minimum-variance input and state estimator based on a linear time invariant math model taking the form of a digital filter.

### CROSS-REFERENCE TO RELATED APPLICATIONS

This application claims the benefit of provisional patent application Ser. No. 61/636,092, filed 2012 Apr. 20 by the present inventors.

### BACKGROUND

This application relates to force and moment components of airborne vehicles, particularly to the determination of dynamic force and moment components.

### BACKGROUND—PRIOR ART

The following is a tabulation of some prior art that presently appears relevant:

U.S. Patents

| Patent Number | Kind Code | Issue Date | Patentee |
|---|---|---|---|
| 1,980,195 | B1 | 1934 Nov. 13 | Gerhardt et al. |
| 2,785,569 | B1 | 1957 Mar. 19 | Miller |
| 2,885,891 | B1 | 1959 May 12 | Wilson et al. |
| 2,935,870 | B1 | 1960 May 10 | Lyons |
| 3,258,959 | B1 | 1966 Jul. 05 | Deegan |
| 3,401,558 | B1 | 1968 Sep. 17 | Stouffer et al. |
| 3,412,604 | B1 | 1968 Nov. 26 | Iandolo |
| 3,447,369 | B1 | 1969 Jun. 03 | Horanoff et al. |
| 3,878,713 | B1 | 1975 Apr. 02 | Mole |
| 4,845,993 | B1 | 1989 Jul. 11 | Horne et al. |
| 4,938,059 | B1 | 1990 Jul. 03 | Faucher et al. |
| 5,201,218 | B1 | 1993 Apr. 13 | Mole |
| 5,663,497 | B1 | 1997 Sep. 02 | Mole |

During the design of airborne vehicles the aerodynamic behavior of the vehicle is assessed for considerations of performance, trajectory, stability, and control. In order to characterize the aerodynamic behavior, the six components of force and moment present on the vehicle at various attitudes and conditions must be determined. These six aerodynamic forces consist of drag, lift, and side forces as well as pitching, yawing, and rolling moments. The determination of these aerodynamic forces is commonly performed by creating a model of the aerodynamic vehicle and exposing it to a known aerodynamic flow in a wind tunnel. The forces on the model in the wind tunnel are determined by a balance on which the model is mounted.

Originally, wind tunnel balances were developed to one or more component of static load. In U.S. Pat. No. 1,980,195 (1934) Gerhardt et al. show a wind tunnel balance capable of measuring lift and drag. The balance of Gerhardt et al. is quite large, and in U.S. Pat. No. 2,785,569 (1957) Miller discloses a balance that measures all six components of aerodynamic force. Miller's balance makes use of strain gauges for measurement to achieve a relatively compact device which can fit entirely within a wind tunnel model. Several additional types of compact balances have been proposed—for example, in U.S. Pat. No. 3,412,604 (1968), U.S. Pat. No. 3,447,369 (1969), U.S. Pat. No. 4,938,059 (1990), U.S. Pat. No. 5,201,218 (1993), U.S. Pat. No. 5,663,497 (1997). Additionally, balances have been developed with means for supplying compressed fluid to the model—for example U.S. Pat. No. 3,878,713 (1975) and U.S. Pat. No. 4,845,993 (1989).

In general the methods discussed above achieved static load measurement by measuring the forces over a length of time and taking the average value. This approach is based on the underlying assumption that while the structural dynamic behavior of the model support structure will influence the force measurements at discrete time points, this influence will average out when measurements are taken over sufficient time. As such, none of the approaches discussed above address the problem of dynamic force measurement.

Dynamic force measurement has been addressed for several applications. In U.S. Pat. No. 2,885,891 (1959), Wilson et al. propose a method for measuring the dynamic forces distributed along a wing. In U.S. Pat. No. 2,935,870 (1960), Lyons shows a method for measuring skin friction forces. In U.S. Pat. No. 3,258,959 (1966) Deegan shows a method for measuring the thrust in a single direction from an engine. While these approaches present advances in the area of dynamic force measurement, none of these approaches are suitable to measuring the six components of total force and moment on a wind tunnel model.

In U.S. Pat. No. 3,401,558 (1968) Stouffer et al. proposes a system to compensate for inertia forces that is applicable to wind tunnel model force measurement. This method requires special equipment in order to collect the data. Special equipment needed includes amplifiers, gain adjustors, phase correlators, and phase inverters. The environment of modern wind tunnel tests is such that incorporation of such equipment into the data processing system is often difficult. In addition, this approach requires detailed analysis to identify the proper placement of the accelerometer on the model to achieve cancellation of inertia loads with this approach. This must be done experimentally prior to conducting the desired wind tunnel testing, and the location needed for this accelerometer is dependent on the mass properties of the model as well as the stiffness and mass properties of the sting, which are often not perfectly known. In practice, this means that the accelerometer location must be determined for each model and sting. This is a particularly cumbersome requirement, since it means that models must be designed to accommodate accelerometers placed at locations that are undetermined at the time of design. For many wind tunnel models that face challenging volume constraints due to other testing requirements, this limitation can prohibit the implementation of this approach.

Furthermore, extension of Stouffer's approach to measure multiple force/moment components is not straightforward. While it might be theoretically possible to select placement of accelerometers and tune electrical components to counteract all six rigid body inertial terms, I have not found implementation to be practical.

Furthermore, Stouffer's approach does not account for changes in the inertial influence on the measured force data due to variation in the mode shape and thereby the modal mass as the model and supporting structure vibrate at different frequencies. Structural vibrations at a range of frequencies will include participation from multiple natural vibration modes. I have found that these vibrations will result in apparent variations in mass.

### ADVANTAGES

In accordance with one or more embodiments several advantages of one or more aspects are as follows: to provide force measurement systems and methods that compensate for dynamic effects, that require relatively little auxiliary equipment during testing, that require relatively little modification to the wind tunnel model, that are applicable to measurement of all six components of force and moment, and that account for inertial forces across a broad frequency range. Other advantages of one or more aspects will be apparent from a consideration of the drawings and ensuing description.

### DRAWINGS—FIGURES

FIG. 1 shows a partially schematic, perspective view of a model supported by a sting in accordance with an embodiment of the disclosure.

FIG. 2 shows a partially schematic, exploded illustration of a force measurement system in accordance with an embodiment of the disclosure.

FIG. 3 shows a flow diagram of one embodiment of a development process.

FIG. 4 shows a flow diagram of one embodiment of a measurement process.

FIG. 5 shows a flow diagram of an alternate embodiment of a measurement process.

FIG. 6 shows a flow diagram of an alternate embodiment of a measurement process.

DRAWINGS-REFERENCE NUMERALS

| | | | |
|---|---|---|---|
| 100: | system | 110: | model |
| 112: | sting | 202: | balance |
| 204: | sensors | 206: | data acquisition system |
| 208: | data analysis system | 210: | accelerometers |
| 212: | strain gauges | 214: | rate gyroscopes |
| 215: | wires | 216: | processor |
| 217: | balance/acquisition link | 218: | data collector |
| 219: | acquisition/analysis link | 220: | development process |
| 222: | measurement process | 310: | known forces |
| 312: | model support structure | 314: | sensor data |
| 316: | system identifier | 318: | math model |
| 320: | force estimator | 410: | aerodynamic forces |
| 412: | measured aerodynamic forces | 510: | force measurement process |
| 512: | motion estimator | 514: | elastic force estimator |
| 516: | inertial force estimator | 518: | inertial forces |
| 520: | elastic forces | 522: | force combiner |
| 610: | force measurement process | 612: | aeroelastic force estimator |
| 614: | aeroelastic force increment | | |

### DETAILED DESCRIPTION

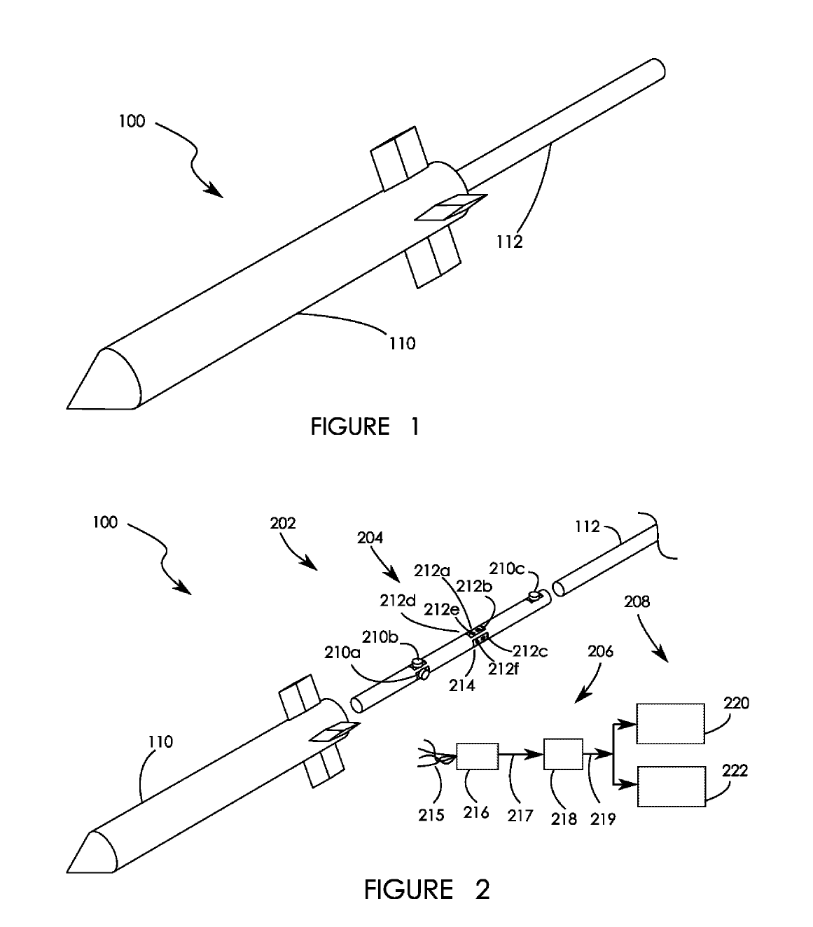

The present disclosure is directed generally to systems and methods for determining dynamic forces present on wind tunnel models. Although the following disclosure sets forth several embodiments, several other embodiments can have different configurations, components and/or steps than those described in this section. In particular, other embodiments may have additional elements and/or may lack one or more of the elements described below with reference to FIGS. 1-4.

Many embodiments of the disclosure described below may take the form of computer-executable instructions, including routines executed by a programmable computer. Those skilled in the relevant art will appreciate that embodiments of the disclosure can be practiced on computer systems other than those shown and described below. Aspects of the disclosure can be embodied in a special-purpose computer or data processor that is specifically programmed, configured or constructed to perform one or more of the computer-executable instructions described below. Accordingly, the term “computer” as generally used herein refers to any appropriately configured data processor and can include Internet appliances and hand-held devices, including palm-top computers, wearable computers, cellular or mobile phones, multi-processor systems, processor-based or programmable consumer electronics, network computers, minicomputers, embedded processors, and the like. Information handled by these computers can be presented at any suitable display medium, including a CRT display or an LCD.

Aspects of the disclosure can also be practiced in distributed environments, where tasks or modules are performed by remote processing devices that are linked through a communications network. In a distributed computing environment, program modules or subroutines may be located in local and remote memory storage devices. Aspects of the disclosure described below may be stored or distributed on computer-readable media, including magnetic or optically readable or removable computer disks, as well as distributed electronically over networks. In particular embodiments, instructions and/or other aspects of the disclosure are carried by or included in data structures and transmissions.

FIG. 1 is a partially schematic, perspective illustration of an overall system 100 that includes a model 110 supported by a sting 112. In the embodiment shown in FIG. 1, the model 110 is representative of a missile. In other embodiments, the model 110 can be representative of a transport aircraft or other aerodynamic or hydrodynamic vehicle or other body on which the fluid dynamic forces are of interest. In the embodiment shown in FIG. 1, the model is aligned with the axis of the sting. Alternate embodiments include other orientations of the model relative to the sting. In any of these embodiments, the model 110 may be subjected to dynamic force conditions in a testing environment suitable for determining fluid dynamic forces such as a wind or water tunnel environment. Aspects of the present disclosure described further below with reference to FIGS. 2-4 are directly related to the measurement of such conditions.

FIG. 2 is a partially schematic, partially exploded enlarged illustration of the system 100. This figure illustrates additional components that provide measurements of dynamic forces. For purposes of illustration, many of the components shown in FIG. 2 are not drawn to scale. In general terms, the system 100 includes multiple sensors 204 that direct sensor signals to a data acquisition system 206 via one or more communication links. As the information is transmitted, it may also be processed or partially processed. The information is transmitted to a data analysis system 208 which includes a development process 220 and a measurement process 222.

The sensors 204 can be configured to monitor one or more of the six components of force and one or more of the six components of motion applicable to the model 110. For example, in a particular embodiment, the sensors 204 can included multiple strain gauges 212 (six are illustrated as strain gauges 212a-212f), one or more accelerometers 210 capable of measuring acceleration in one, two, or three axes (two accelerometers 210 capable of measuring acceleration in three axes each are illustrated as accelerometers 210a-210b), and one or more rate gyroscopes 214 capable of measuring angular rate in one two or three axes (one rate gyroscope 214 capable of measuring angular rate in three axes is illustrated). A purpose of the foregoing sensors is to measure conditions at the balance 202 such as internal loads and linear and angular motion. Aspects of the present disclosure that focus on measuring linear and angular motion can be relatively simple and cost effective.

Aerodynamic forces applied to the model 110 will be transmitted to the balance 202. This will result in internal loads in the balance 202. Accordingly, the strain gauges 212 can be positioned on the balance 202 to measure these internal loads. In a particular embodiment, the strain gauges 212 can include three strain gauges 212a, 212b, and 212c positioned 90° apart from each other around the circumference of the balance 202. The measured strain is then linearly combined to achieve measurements of force in the axial direction as well as moments in the pitching and yawing directions. Three additional strain gauges 212d, 212e, and 212f can be positioned at the same locations and are oriented at a 45° angle relative to the major axis of the balance 202. The measured strain can then linearly superposed to achieve measurement of force in the vertical and lateral directions as well as moment in the rolling direction. In particular embodiments, the balance 202 can be outfitted with additional strain gauges. In other embodiments, the number of strain gauges 212 can be reduced. In still further embodiments, measurement means other than strain gages may be used to measure the internal loads in the balance 202. These measurement means may be based on optical, magnetic, electrical, or other phenomena.

Aerodynamic forces applied to the model 110 will result in motion of the model 110 and balance. Accordingly, accelerometers 210 and rate gyroscopes 214 can be positioned on the balance 202 or model 110 to measure this motion. In a particular embodiment, two tri-axial accelerometers 210a and 210c can be positioned 90° apart from each other around the circumference of the balance 202 with offset axial locations. The measured linear accelerations can be used to determine that linear and angular acceleration in all six axes. This acceleration data can be processed to obtain velocity and acceleration. In a particular embodiment, a three axis rate gyroscope 214 can be positioned on the balance 202 or model 110. The measured angular rates can be processed to obtain angular position and acceleration. In particular embodiments, the balance 202 or model 110 can be outfitted with additional accelerometers and rate gyroscopes. In other embodiments, the number of accelerometers can be reduced. Some embodiments can omit rate gyroscopes 214. Some embodiments can omit accelerometers 210. In a particular embodiment, one tri-axial accelerometer and one tri-axial rate gyroscope can be included on the balance 202. An advantage of this arrangement is that is simpler than one that includes more sensors. In some embodiments, all motion measurement sensors 204 can be located on the balance 202. Advantages of this arrangement are that it is simpler, more cost effective, and more reusable than arrangements that include sensors on the model. In alternate embodiments, the translational and angular position, velocity, and/or acceleration can be measured using any other appropriate means such as instruments based on electrical, optical, magnetic effects.

Various sensor types can be used in various embodiments. In a particular embodiment, piezoelectric strain gauges 212 can be used with piezoelectric accelerometers 210 and MEMS rate gyroscopes 214. In alternate embodiments, MEMS accelerometers can be used 210. In other embodiments, inertial measurement units consisting of rate gyroscopes and accelerometers on a single printed circuit board can be used.

The data acquisition system 206 can include a processor 216 connected to a data collector 218. The sensor signals can be transmitted to the processor 216 via wires 215 (connection of wires to sensors not shown in FIG. 2). The processor can process or partially process the raw data received from the sensors 204. For example, strain measurements aligned with the strain gauges 212 can be converted to measurements of the forces and moments in the six aerodynamic axes. In some embodiments, the raw signals from the sensors (e.g., voltages) can be converted to other engineering-unit values. In some embodiments, the data can be converted from analog to digital. In some embodiments, the data can be low-pass or band-pass filtered. The data are then transmitted from the balance 202 to the data analysis system 208 via a suitable transmission mode (e.g., wired, wireless, satellite, mesh network, wireless mesh network, Ethernet or other mode). The system can use existing protocols, e.g., supervisory control and data acquisition (SCADA) protocols. In a particular embodiment, this transmission can be conducted via a data collector 218. Accordingly, data can be transmitted to the collector 218 via a balance/acquisition link 217, and then transmitted to the data analysis system 208 via a acquisition/analysis link 219. In a particular embodiment, the data collector 218 can include a computer system located in a wind tunnel control room. In other embodiments, the components of the data acquisition system can be integrated in a single device.

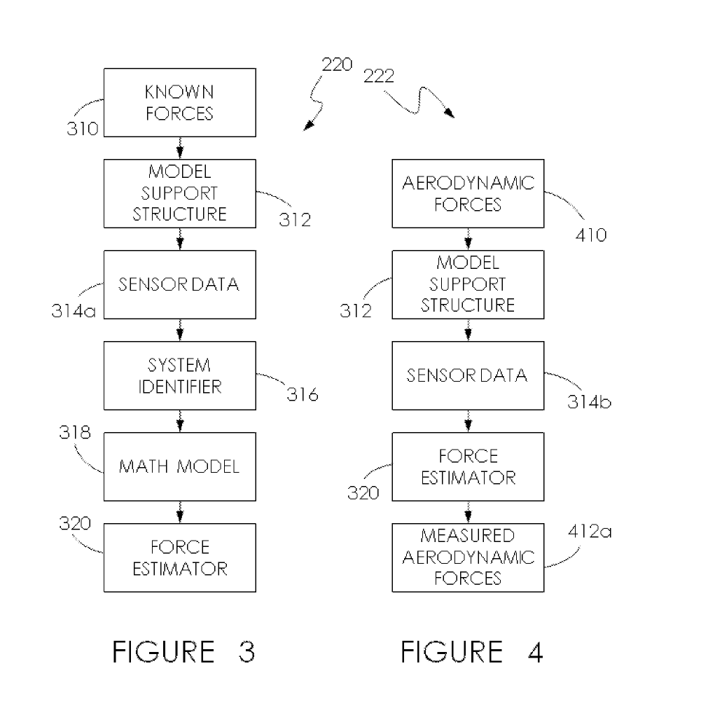

FIG. 3 illustrates the development process 220 in accordance with an embodiment of the disclosure. Known forces 310 can be applied to the model 110 in one or more directions at one or more locations. Existing methods for applying and measuring the known forces 310 can be used (e.g., dynamically tuned instrumented hammer, shaker connected to load cell). The known forces 310 excite a model support structure 312 resulting in sensor data 314a. The sensor data 314a can include data collected from one or more of the sensors 204 as well the measured force data. The sensor data 314b can be passed to the system identifier 316. The system identifier develops a mathematical representation of the structural dynamic behavior or math model 318 that is representative of the model support structure 312. In a particular embodiment, the system identifier 316 can make use of least squares techniques and performs the subspace projection approach. In other embodiments, the system identifier 316 can use an instrumental-variable method or a frequency domain least squares methods. The math model 318 can be a state space model, an auto-regressive moving average model, or a transfer function model in various embodiments. A force estimator 320 is generated based on the math model 318. In one embodiment the force estimator 320 can be the optimal unbiased minimum-variance input and state estimator based on a linear time invariant math model and takes the form of a digital filter. In alternate embodiments, the force estimator 320 can operate on frequency domain data using frequency domain math models.

FIG. 4 illustrates the measurement process 222 in accordance with an embodiment of the disclosure. Unknown aerodynamic forces 410 can excite the model support structure 312. The resulting motion of the model 110 and balance 202 can result in sensor data 314b. The sensor data 314b can include data collected from one or more of the sensors 204. The sensor data can be processed by the force estimator 320. In a particular embodiment, this processing can be performing a digital filtering operation in the time domain. In alternate embodiments, this processing can be performed on frequency domain sensor data 314b using a force estimator 320 developed using frequency domain techniques. The operation of the force estimator 320 on the sensor data 314b can result in measured aerodynamic forces 412.

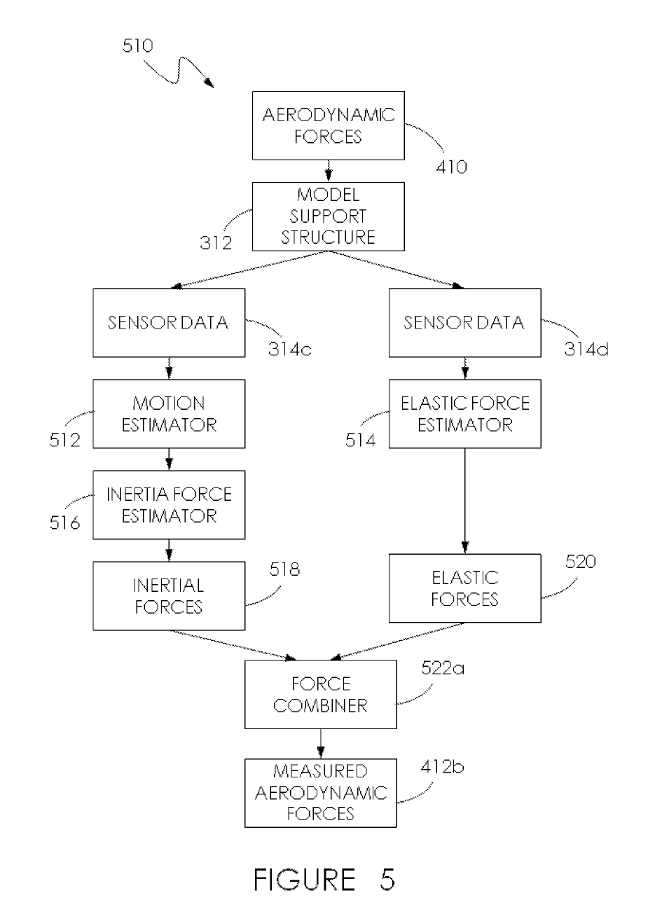

FIG. 5 illustrates an embodiment in which aerodynamic forces are determined from an algebraic combination of the inertia loads and elastic loads. The measurement process 510 includes excitation of the model support structure 312 by unknown aerodynamic forces 410. The resulting response of the model leads to sensor data 314b and 314c. A motion estimator 512 determines the motion of the wind tunnel model. In a particular embodiment, this motion estimator determines the position, velocity, and acceleration of the model in three translation and three rotational degrees of freedom. An inertial force estimator 516 computes inertial forces 518 using the estimated motion. In one embodiment, said force estimator can multiply the acceleration in the six degrees of freedom by the model mass. In alternate embodiments, said force estimator can apply different mass values for motion at different frequency to account for the participation of different structural dynamic modes. The inertial forces are combined algebraically with the elastic forces 520 within a force combiner 522a resulting in measured aerodynamic forces 412b. This combination can include addition of elastic and inertial forces to obtain applied forces.

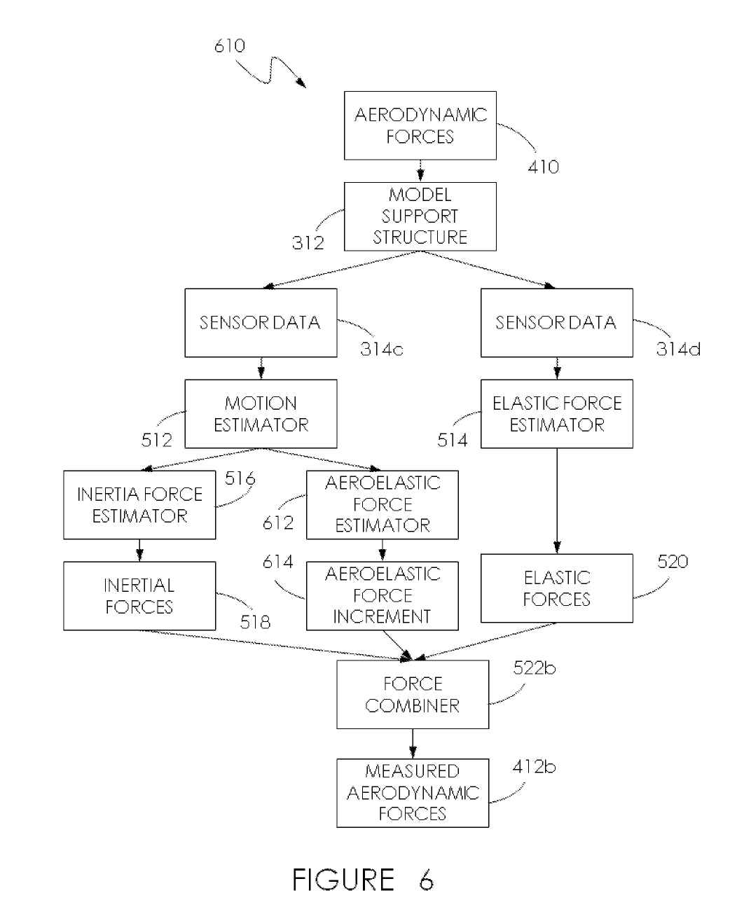

FIG. 6 illustrates an alternate embodiment where an aeroelastic force increment is calculated 614. Said increment is calculated in an aeroelastic force estimator 612. This force estimator can use motion data along with aeroelastic stability derivatives approximated analytically a priori. In alternate embodiments, optimization techniques such as gradient descent can be used to identify aeroelastic stability derivatives from sensor data. Said aeroelastic force increment is combined with inertial forces and elastic forces to obtain measured aerodynamic forces at the nominal operating condition.

From the foregoing, it will be appreciated that specific embodiments of the disclosure have been described herein for purposes of illustration, but that various modifications may be made without deviating from the disclosure. For example, the disclosed sensors may have different arrangements and/or configurations in other embodiments. The model may have alternate orientation relative to the sting. Certain aspects of the disclosure described in the context of particular embodiments may be combined or eliminated in other embodiments. Further, while advantages associated with certain embodiments have been described in the context of those embodiments, other embodiments may also include such advantages, and not all embodiments need necessarily exhibit such advantages to fall within the scope of the present disclosure. Accordingly, the disclosure can encompass other embodiments not expressly shown or described herein.

The invention claimed is:

1. A force measurement system, comprising:
a balance;
at least one sensor carried by said balance; and
a processor operatively coupled to said at least one sensor, said processor being programmed with instructions that, when executed, receive and process signals measured by said sensor.

2. The system of claim 1 wherein said processor is programmed with instructions to identify a math model of a model support structure.

3. The system of claim 2 wherein said math model is in state space form.

4. The system of claim 1 wherein said processor is programmed with instructions to generate a force estimator.

5. The system of claim 4 wherein said force estimator is an optimal unbiased minimum-variance input and state estimator based on a linear time invariant math model and takes the form of a digital filter.

6. The system of claim 4 wherein said force estimator operates in the frequency domain using frequency domain math models.

7. The system of claim 1 wherein said at least one sensor includes at least one strain gauge.

8. The system of claim 1 wherein said at least one sensor includes at least one accelerometer.

9. The system of claim 1 wherein said at least one sensor includes at least one rate gyroscope.

10. The system of claim 1 wherein said at least one sensor includes at least one load cell.

11. The system of claim 1 wherein said processor is programmed with instructions to estimate aerodynamic forces.

12. A method for measuring dynamic forces, comprising:
receiving information from at least one sensor;
applying forces to a model in at least one direction at at least one location; and
identifying a math model of a model support structure.

13. The method of claim 12, wherein said math model is in state space form.

14. The method of claim 13, further comprising generating a force estimator.

15. The method of claim 14 wherein said force estimator is an optimal unbiased minimum-variance input and state estimator based on a linear time invariant math model and takes the form of a digital filter.

16. The method of claim 15 wherein said force estimator operates in the frequency domain using frequency domain math models.

17. The method of claim 12 further comprising estimating aerodynamic forces.

18. A method for measuring dynamic forces, comprising:
receiving information from at least one sensor;
estimating elastic force;
estimating model motion;
estimating inertial force from model motion;
combining inertial force and elastic force to obtain measured aerodynamic force.

19. The method of claim 18, wherein estimating inertial force includes multiplication of constant model mass by model acceleration, or includes application of frequency dependent mass due to structural mode participation.

20. The method of claim 18, further comprising:
estimating aeroelastic force increment from model motion;
combining aeroelastic force, inertial force and elastic force to obtain measured aerodynamic force.
